(19) United States
(12) Patent Application Publication
(10) Pub. No.: US 2019/0085429 A1
(43) Pub. Date: Mar. 21, 2019

(54) SX-NICKEL ALLOY HAVING IMPROVED TMF PROPERTIES, RAW MATERIAL AND COMPONENT

(71) Applicant: SIEMENS AKTIENGESELLSCHAFT, München (DE)

(72) Inventors: EIKE KOHLHOFF, BERLIN (DE); BRITTA STÖHR, BERLIN (DE)

(21) Appl. No.: 16/081,972

(22) PCT Filed: Jan. 26, 2017
(86) PCT No.: PCT/EP2017/051630

§ 371 Date: Sep. 4, 2018

(30) Foreign Application Priority Data
Mar. 8, 2016 (DE) 10 2016 203 724.2

(51) Int. Cl. C22C 19/05; F01D 5/28

(52) U.S. Cl. CPC C22C 19/057; F05D 2300/173; F05D 2300/17; F01D 5/28

(57) ABSTRACT

Provided is an improved composition of a nickel-based superalloy. The improved composition may have Ni-8Cr-10Co-0.6Mo-8Ta-1.25Re-5.7Al-OTi-0.1Hf-0.25Si-0.008B-0.0207C-0.02Y.

### CROSS-REFERENCE TO RELATED APPLICATIONS

This application claims priority to PCT Application No. PCT/EP2017/051630, having a filing date of Jan. 26, 2017, based on German Application No. 10 2016 203 724.2, having a filing date of Mar. 8, 2016, the entire contents both of which are hereby incorporated by reference.

### FIELD OF TECHNOLOGY

The following relates to a nickel-based SX alloy having improved TMF properties, to a raw material and to a component.

### BACKGROUND

In order to permit a higher turbine inlet temperature and thus greater efficiency, nickel-based SX materials are presently the focus of research. These materials are thought to have substantially greater creep resistance in comparison to the known SX materials, and to have markedly greater tensile strength in particular at high temperatures.

However, initial research into the TMF behavior shows that, at lower temperatures (373K) and large tensile oscillation amplitudes, the materials tend to brittle behavior and thus to reduced TMF lives.

The LCF life at large tensile oscillation amplitudes is also reduced by the brittle fracture behavior between room temperature and 923K.

Whereas previously the creep properties were considered to be decisive for lifespan, TMF properties are increasingly significant. This is due to improved cooling air designs, which produce localized cold and hot regions: At the same time, the time periods of stationary use are ever shorter. The systematic investigation of TMF properties is still in its infancy. For that reason, the problems of this material are as yet unknown.

### SUMMARY

The invention according to one embodiment therefore has the object of solving the aforementioned problem.

The description shows merely exemplary embodiments of the invention.

For example, a material having the following composition is advantageous:

A nickel-based alloy,
at least having (in wt %):

| | | |
|---|---|---|
| chromium (Cr) | 7.0%-9.0%, | in particular 8.0%, |
| cobalt (Co) | 9.0%-11%, | in particular 10%, |
| molybdenum (Mo) | 0.4%-0.8%, | in particular 0.6%, |
| tantalum (Ta) | 7.0%-9.0%, | in particular 8.0%, |
| rhenium (Re) | 1.0%-1.25%, | in particular 1.25%, |
| aluminum (Al) | 5.0%-6.5%, | in particular 5.7%, |
| hafnium (Hf) | 0.08%-0.12%, | in particular 0.1%, |
| silicon (Si) | 0.018%-0.32%, | in particular 0.25%, |
| boron (B) | 0.017%-0.023%, | in particular 0.008%, |
| carbon (C) | 0.006%-0.10%, | in particular 0.0207%, |
| yttrium (Y) | 0.017%-0.023%, | in particular 0.02%. |

This material differs from previous Ni—SX compositions by a substantially higher proportion of chromium (Cr), a reduced proportion of rhenium (Re), the addition of silicon (Si) and yttrium (Y), and by the fact that it contains no titanium (Ti), with the exception of contamination amounting to no more than 0.1 wt %.

The novel material has the following advantages:

The addition of silicon (Si) increases the TMF strength by a factor of 2. This effect is due to the following action of silicon:

Silicon (Si) improves oxidation resistance.

The addition of silicon (Si) increases the proof stress at low temperatures which, in the TMF test, leads to reduced compressive stresses in the high-temperature region under out-of-phase conditions, and thus to a lower risk of re-crystallization.

The LCF life is increased by the increased proof stress at low temperatures and large tensile oscillation amplitudes. The reduction in the rhenium (Re) fraction lowers the risk of TCP phase formation, which would have a very detrimental effect on the TMF behavior if formed during operation.

In combination with the removal of titanium (Ti), the reduction in rhenium (Re) permits a further increase in the chromium content without stabilizing undesired TCP phases. Thus, the novel material should have oxidation properties at least equal to those of alloy 247.

In that context, the addition of yttrium (Y) means that the material has particularly good cyclical oxidation properties (improved adhesion of the Al2O3 outer layer).

In the titanium-free alloy, the silicon (Si) is predominantly incorporated in the γ′-phase, whereas in titanium-containing materials it is incorporated in the γ-phase. The enrichment of silicon (Si) in the γ-phase is undesirable since this would promote the precipitation of brittle phases (for example the G-phase) into the ducts. Furthermore, the incorporation of silicon into the γ′-phase increases the shear strength thereof.

The reduced proportion of rhenium (Re) makes the alloy substantially less costly. The γ′-fraction changes only insignificantly.

Accordingly, the creep resistance remains almost unaffected.

The alloy presented above is entirely novel. If the TMF life can indeed be increased by a factor of 2, the following advantages result:

Increased life of the turbine blades,

Reduced LCC,

Taking a technical lead by virtue of own SX alloy.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A nickel-based alloy,
comprising (in wt %):

| | |
|---|---|
| chromium (Cr) | 7.0%-9.0%, |
| cobalt (Co) | 9.0%-11%, |
| molybdenum (Mo) | 0.4%-0.8%, |
| tantalum (Ta) | 7.0%-9.0%, |
| rhenium (Re) | 1.0%-1.25%, |
| aluminum (Al) | 5.0%-6.5%, |
| hafnium (Hf) | 0.08%-0.12%, |
| silicon (Si) | 0.018%-0.32%, |
| boron (B) | 0.017%-0.023%, |
| carbon (C) | 0.006%-0.10%, |
| yttrium (Y) | 0.017%-0.023%, |

2. A raw material,
in particular a powder,
comprising the alloy as claimed in claim 1.

3. A component,
comprising the alloy as claimed in claim 1.

4. The component as claimed in claim 3,
wherein the component is a turbine component.

5. The alloy as claimed in claim 1, wherein the alloy contains no titanium (Ti).

6. The component of claim 4, wherein the turbine component is a turbine blade.

7. The nickel-based alloy of claim 1, comprising (in wt %):

| | |
|---|---|
| chromium (Cr) | 8.0%, |
| cobalt (Co) | 10%, |
| molybdenum (Mo) | 0.6%, |
| tantalum (Ta) | 8.0%, |
| rhenium (Re) | 1.25%, |
| aluminum (Al) | 5.7%, |
| hafnium (Hf) | 0.1%, |
| silicon (Si) | 0.25%, |
| boron (B) | 0.008%, |
| carbon (C) | 0.0207%, and |
| yttrium (Y) | 0.02%. |

8. The nickel-based alloy of claim 7, wherein the alloy contains no Titanium (Ti).
